(19) United States
(12) Patent Application Publication
(10) Pub. No.: US 2014/0275347 A1
(43) Pub. Date: Sep. 18, 2014

(54) MODIFIED NANO-CLAY MATERIALS AND NANOCOMPOSITES MADE THEREFROM

(71) Applicant: NANOSCIENCE ENGINEERING CORPORATION, West Bloomfield, MI (US)

(72) Inventors: Pranav Nawani, Farmington Hills, MI (US); David E. Burnett, Birmingham, MI (US); Roy G. Crawford, Detroit, MI (US)

(73) Assignee: NANOSCIENCE ENGINEERING CORPORATION, West Bloomfield, MI (US)

(21) Appl. No.: 13/836,300

(22) Filed: Mar. 15, 2013

(51) Int. Cl. C09C 1/42; C08F 134/02; C08F 234/02; C08K 5/56; C08L 23/06; C08L 23/12; C08L 45/00; C08K 3/34; C07F 19/00

(52) U.S. Cl. CPC C09C 1/42; C08K 3/346; C08F 134/02; C08F 234/02; C07F 19/00; C08L 23/06; C08L 23/12; C08L 45/00; C08K 5/56
USPC 523/467; 524/445; 524/447; 525/327.8; 549/206; 525/207; 524/112; 252/397; 252/400.3; 106/487; 106/416; 524/789; 252/188.28

(57) ABSTRACT

A nano-clay material that exhibits improved compatibility with polymers is described. The nano-clay material may be mixed with polymers to produce a nano-clay polymer nanocomposite material including reduced levels of clay loading. Methods for making the nano-clay nanocomposite material and articles of manufacture from the nanocomposite material are also described.

### TECHNICAL FIELD

The present disclosure is related to modified nano-clay materials compatible with various polymers to make polymer nanocomposites using such nanofillers. The improved compatibility of the nano-clay material allows the use of reduced quantities of the nano-clay in the nanocomposite. Methods of producing the polymer nanocomposites and articles of manufacture including the nano-clay polymer nanocomposites are also described.

### BACKGROUND

The use of plastics in various industries has been steadily increasing due to their light weight and continual improvements to their properties. For example, in the automotive industry, polymer-based materials may comprise a significant portion, e.g., at least 15 percent, of a given vehicle's weight. These materials are used in various automotive components, such as, interior and exterior trim and side panels. As the industry seeks to improve fuel economy, more steel and aluminum parts, such as fuel containers, etc., may be targeted for replacement by polymer-based materials.

For example, improvements in the physical properties of polymers are desired in order to meet more stringent performance requirements. Such physical properties include toughness, strength, stiffness, dimensional stability, modulus, heat deflection temperature, thermal properties, barrier properties, and rust and dent resistance. Improved physical properties may reduce manufacturing costs by reducing the part thickness and weight of the manufactured part and the manufacturing time thereof. For example, reducing weight of an automobile results in higher mileage and reducing the weight of packaging material can save on transportation costs, etc.

There are a number of ways to improve the properties of a polymer, including reinforcement with particulate fillers, carbon or glass fibers, etc. It is known that polymers reinforced with nanometer-sized platelets or particles of layered silicates or clay can significantly improve the mechanical properties at much lower loading than conventional fillers. (See U.S. Pat. No. 6,469,073 issued to Manke et al. (2002)). This type of composite is termed a “nanocomposite.” More specifically, polymer-silicate nanocomposites are compositions in which nano-sized particles of a layered silicate, e.g., montmorillonite clay, are dispersed into a thermoplastic or a thermoset matrix. The improvement in mechanical properties of nanocomposites is believed to be due to factors such as the increased surface area of the particles.

The transition of length scale from micrometer to nanometer yields dramatic changes in physical properties of the polymer nanocomposite materials, in part because of the increase in surface area for nanoscale particles for a given volume of filler resulting in higher degree of interaction with polymer matrix. One approach to effective property enhancement is dispersion of the nanofillers in polymers to form nanoparticle polymer nanocomposites; as the improvements will depend not only on the properties of individual components, but also on their morphology and interfacial interactions. The final properties of polymer nanocomposites may be dependent upon various filler properties such as their size, area, aggregate structure, surface chemistry, aspect ratio, and interaction of the nanoparticle with polymer matrix, all of which affect the dispersion of the nanofillers in polymer matrices.

Polyethylene and polypropylene nanocomposites are commonly used as the polymer matrix material in a variety of commodity products. Various nano-scale fillers have been used to develop nanofiller particulates to produce nanocomposites with improved physical, mechanical and barrier properties. For example, clay which is a sheet like filler may be used as a common filler material for developing polyethylene (“PE”) or polypropylene (“PP”) based nanocomposites. Owning to its sheet like structure, clay particulates provide large areas for interaction with matrix and the layered platelet structure provides tortuous path for any permeating molecule. However, one problem faced by chemists or engineers while developing clay-based PE or PP nanocomposites is the limited compatibility of PE or PP with clay. Polymer grafted (PE or PP) maleic anhydride-based compounds are used as compatibilizer and are introduced at the time by mixing to develop PE or PP clay nanocomposite material. However, poly-ethylene grafted maleic anhydride when used as a conventional compatibilizer requires up to 30% by weight loading of the compatibilizer in the nanocomposite matrix to provide acceptable dispersion of the nano-clay in the polymeric matrix. Even though the compatibilizer aids in dispersion of clay in polymer matrix, the large loading requirement may affect other polymer nanocomposite properties adversely, such as, for example, physical and mechanical properties, thereby making the use of a compatibilizer an unattractive option.

Polymer nanocomposite materials have been used to provide a barrier against outside environment. For example, for food and medicine on the shelf, oxygen (O₂) is unwanted element due to undesired oxidation or other reactions that may take place hence providing a barrier against oxygen is imperative in packaging material. Reducing the oxygen permeability through packaging material (often PE or PP based) can reduce or eliminate undesired oxidation reactions and/or other undesired reactions. Oxygen scavenging materials are useful in packaging material especially for food, electronics, and medicines to provide longer shelf life. Studies have shown that iron-based compounds are among the most common oxygen scavenging agents and are typically used in form of permeable sachets filled with an iron-compound (i.e., iron carbonate, iron/sodium alloy, etc.) and placed into the food or electronics package. Oxygen readily permeates the sachet and reacts with the scavenging compound instead of the packaged material. The most used Oxygen scavengers are based on the principle of iron oxidation. Introducing an oxygen scavenger directly into a polymer matrix of a nanocomposite can result in deterioration of polymeric properties, hence there is a need of introducing these scavengers in most elegant way such that properties are not affected and oxygen scavenging can take place.

Problems exist when utilizing conventional compatibilizing agents and scavenger compounds with clays to produce dispersed nano-clay polymer nanocomposites. Thus, nano-clay polymer nanocomposites in which the loading of the compatibilizing agent is reduced or zero and having oxygen scavengers are desired.

### SUMMARY

The present disclosure provides modified nano-clay particulates which display improved compatibility with polymeric materials.

According to a first embodiments, the present disclosure provides a modified nano-clay for a polymer nanocomposite material comprising nano-scale clay particles having gallery spacing within the clay structure; and a modifying compound selected from a compatibilizer moiety, a scavenger moiety or combination thereof, wherein the compatibilizer moiety or the scavenger moiety is intercalated within the gallery spacing of the clay particles, polymerized within the gallery spaces or on the surface of the clay, grafted to or from the clay particles, or deposited on at least a portion of a surface of the clay particles.

Another embodiment of the present disclosure provides a polymer nanocomposite material comprising a matrix phase comprising a polymer and a dispersed phase comprising modified nano-clay particles. According to there embodiments, the modified nano-clay particles comprise nano-scale clay particles having gallery spacing within the clay structure; and a modifying compound selected from a compatibilizer moiety, a scavenger moiety or combination thereof, wherein the compatibilizer moiety or the scavenger moiety is intercalated within the gallery spacing of the clay particles, polymerized within the gallery spaces or on the surface of the clay, grafted to or from the clay particles, or deposited on at least a portion of a surface of the clay particles.

Further embodiments of the present disclosure provides a process for producing modified nano-clay particles comprising mixing a clay aggregate having gallery spacing within the clay structure with a modifying compound selected from a compatibilizer moiety, a scavenger moiety or combination thereof and intercalating the modifying compound into the gallery spacing of the clay structure, polymerizing the modifying compound in situ in the gallery spacing, grafting the modifying compound to or from the clay to provide a modified clay aggregate, or adsorbing the modifying compound on the surface of the clay.

Still other embodiments of the present disclosure provide an article of manufacture comprising the polymer nanocomposite material comprising a matrix phase comprising a polymer and a dispersed phase comprising modified nano-clay particles. According to there embodiments, the modified nano-clay particles comprise nano-scale clay particles having gallery spacing within the clay structure; and a modifying compound selected from a compatibilizer moiety, a scavenger moiety or combination thereof, wherein the compatibilizer moiety or the scavenger moiety is intercalated within the gallery spacing of the clay particles, polymerized in situ within the gallery spacing, or deposited, adsorbed on or grafted to/from at least a portion of a surface of the clay particles.

### BRIEF DESCRIPTION OF THE DRAWINGS

The various embodiments of the present disclosure will be better understood when read in conjunction with the following Drawings wherein:

FIG. 1A illustrates the structural unit of silicate clay. FIG. 1B illustrates the sheet like structure of a clay aggregate and shows the interlayer spacing or gallery spacing (spacing distance=d) between clay silicate sheets.

FIG. 2A illustrates an unmodified organoclay having gallery spacing without a scavenging transition metal ion but contains organic surfactants only. FIG. 2B illustrates a modified clay according to one embodiment of the present disclosure having intercalated oxygen scavenging Fe²⁺ ions in gallery spaces along with surfactants.

### DETAILED DESCRIPTION

According to various embodiments, the present disclosure describes modified nano-clay materials suited for use in forming nano-clay polymer nanocomposite materials with improved compatibility or ability to scavenge undesired compounds, such as O₂. Further, nano-clay polymer nanocomposite materials including the modified nano-clay materials are described. The nano-clay polymer nanocomposites do not require additional compatibilizer compounds or scavenger compounds. Methods for producing the nano-clay polymer nanocomposites are described and articles of manufacture comprising the nano-clay polymer nanocomposites are described.

As generally used herein, the terms “include” and “have” mean “comprising”. As generally used herein, the term “about” refers to an acceptable degree of error for the quantity measured, given the nature or precision of the measurements. Typical exemplary degrees of error may be within 20%, 10%, or 5% of a given value or range of values. Alternatively, and particularly in biological systems, the term “about” may mean values that are within an order of magnitude, potentially within 5-fold or 2-fold of a given value.

As used herein, the term “clay” includes platelet clay particulates having a sheet-like or laminar structure and includes materials such as silicate clay selected from the group consisting of a kaolin-serpentine clay, a sepolite clay, a palygorskite clay, a talc pyrophylite, a smectite clay, a vermiculite clay, a chlorite clay, a mica clay and mixtures of any thereof. Examples of the laminar or sheet-like structure and the gallery spacing of the clays useful in various embodiments of the present disclosure are shown in FIG. 1A, showing the structural unit of silicate clay and FIG. 1B, showing the sheet like structure of a clay aggregate and shows the interlayer spacing or gallery spacing (spacing distance=d) between clay silicate sheets.

In its natural state, clay is made up of stacks of individual particles held together by ionic forces. The spacing between the layers is in the order of about 1 nanometer (nm) which is smaller than the radius of gyration of typical polymers. Consequently, there is a large entropic barrier that inhibits the polymer from penetrating this gap and intermixing with the clay.

As used herein, the term “polymer nanocomposite material” or “nano-clay polymer nanocomposite” means a nanocomposite materials comprising a polymeric matrix phase comprising a homopolymer, copolymer, or blend of two or more polymers, and a dispersed phase comprising the nano-clay materials according to the various embodiments described herein. In specific embodiments, the dispersed phase may also include other additives, such as, but not limited to, pigments, other compatibilizers, oxygen scavengers, stabilizers, UV absorbers, surfactants, and other additives known in the art.

According to certain embodiments, the present disclosure provides for a modified nano-clay for a polymer nanocomposite material comprising nano-scale clay particles having gallery spacing within the clay structure and a modifying compound selected from a compatibilizer moiety, a scavenger moiety or combinations thereof, wherein the compatibilizer moiety or the scavenger moiety is intercalated within the gallery spacing of the clay particles, grafted to the clay particles, or deposited on at least a portion of a surface of the clay particles. As used herein, the phrase “combinations thereof” when used in reference to the modifying compound means modifying compounds having both compatibilizer and scavenger functionality and two or more modifying compounds in which one may comprise a compatibilizer moiety and another may comprise a scavenger moiety. As used herein, the term “compatibilizing moiety” means a compound or molecular structure capable of enhancing interaction between two surfaces such that a homogenous blend of the dispersed phase and the matrix phase is formed and morphology is stabilized. In general, the compatibilizer must be compatible with one phase and create interaction with other for homogenous dispersion. In certain embodiments, compatibilizer may include block polymers which have hard glassy and soft rubbery phase, other compatibilizers may include methacrylate-based polymers, polycaprolactone polyesters, polycaprolactone polyester-poly(tetramethylene glycol) block polyols, methacrylate-terminated reactive polystyrene, and mixtures of aliphatic resins of low or medium molecular weight as described herein. As used herein, the term “scavenger moiety” means a compound or molecular structure capable of scavenging undesired contaminants, thereby preventing reaction or degradation of the nanocomposite material and/or article of manufacture made therefrom, or to avoid permeation of such contaminants across such nanocomposite material. For example, oxygen scavenging materials are useful in packaging material to avoid or eliminate the possibility of undesired oxidation or any other undesired reaction, especially for food and medicine packaging materials. Such modified nanofillers may be used in developing advanced packaging material which can provide longer shelf life to the food or medicine as it provided a barrier against oxygen, and prevent undesired oxidation or other undesired reaction of the package contents.

According to various embodiments, the nano-scale clay particles, clay minerals are the basic component for the preparation of organo nano-clays used in the nano-clay polymer nanocomposites described herein. Clay minerals may be defined as hydrous-layered silicates which, consist of two types of continuous sheet-like structural units. One is a tetrahedral sheet of silica, which is arranged as a hexagonal network in which the tips of all the tetrahedral units point in one direction. The other structural unit (octahedral sheet) consists of two layers of closely packed oxygen or hydroxyl groups in which aluminum, iron or magnesium atoms are embedded at equidistant from oxygen or hydroxyl as shown in FIG. 1A. Stacking of the layers leads to a regular van der Waals gap between the layers called the interlayer space or silicate gallery or gallery spacing (FIG. 1B). Isomorphic substitution within the layers (i.e. of Si by Al or of Si by Mg) generates negative charges at layer surfaces that for some clays may be counterbalanced by monovalent cations such as Na⁺, K⁺, or Li⁺ residing in the interlayer space. For certain classes of clays (i.e. smectites) such cations may be exchanged for other metal or organic cations as described herein. The ability to exchange cations is an important feature of modified nano-clay materials of the present disclosure. Clays suitable for use in the various embodiments described herein include silicates, for example platelet like philosillicate clays, such as kaolin-serpentine clay, sepolite clay, palygorskite clay, talc, pyrophylite clay, smectite clay, vermiculite clay, chlorite clay, mica clay and mixtures of any thereof. Specific embodiments may include dioctahedral smectites, such as montmorillonite clay, beldellite clay, nontronite clay, etc.; trioctahedral smectites, such as saponiteor, hectorite, suconite clay, etc.; kaolinite clays, such as kaolinite, halloysite, dickite, nacrite clays, etc.; serpentine clays, such as chrysotite, antigorite, lizardite clays, etc.; trioctahedral micas, such as blotite clay, etc.; and dioctahedral micas, such as muscovite clay, phengite clay or illite clay, etc. According to specific embodiments the clay particles are particles of a silicate clay selected from the group consisting of a kaolin-serpentine clay, a sepolite clay, a palygorskite clay, a talc pyrophylite, a smectite clay, a vermiculite clay, a chlorite clay, a mica clay and mixtures of any thereof.

Other embodiments of the present nanofillers may include the modification of other inorganic nanofillers, such as, for example carbon black, carbon nanotubes, graphite, graphene, zirconium phosphate, zeolites, talc, calcium carbonate, other aggregate materials, such as platelet aggregate materials, and combinations of any of these material. Nanocomposite materials may be made by treating and modifying these other nanofiller materials with a modifying compound such as a compatibilizer or scavenger, or combination thereof, to form the modified nanofiller using the various intercalating, in situ polymerizing, and grafting from or to strategies described herein.

According to specific embodiments, the nano-scale clay particle of the present disclosure may have a size ranging from 500 nanometers (nm) to 3000 nm prior to processing where the thickness of the clay stack varies from 500 nm to 1000 nm. After processing according to various embodiments described herein, the modified nano-clay particles may have a similar lateral size, but post-processing these particles with have thickness of 1 nm to 100 nm, resulting in reduced density and increased volume for given clay.

According to various embodiments of the modified nano-clay, the modifying compound may be a compatibilizer. The role of the compatibilizer includes enhancing interaction between the surfaces of the dispersed particle and the polymer phase, such that a homogenous blend is formed and morphology is stabilized. In general, the compatibilizer must be compatible with one phase and create interaction with other for homogenous dispersion. Conventional compatibilizers include modified polyolefins that can be dispersed into the matrix phase, most of which contains a polar group enhancing interactions of polymers with other polymer or inorganic fillers resulting in stable product. Maleic anhydride or polymer grafted maleic anhydride has been used as a dispersed compatibilizer with clay particulates in the matrix phase.

According to various embodiments of the present disclosure, the compatibilizer may be introduced into clay galleries which will then make the clay more compatible with various elastomers hence either reducing or eliminating use of compatibilizers in the system. In the present disclosure, the compatibilizer may be introduced into gallery spaces of the clay by an ion exchange process as shown in Equation 1, where X represents an ion of polar polymeric molecule, such as a compatibilizer comprising maleic anhydride residues being used as compatibilizer. According to certain embodiments, these compatibilizers of the present disclosure can penetrate into clay gallery spaces by ion exchange process. According to other embodiments, the compatibilizer may become attached to surface of clay or in the clay gallery spaces by electrostatic interactions or a grafting process by attaching the compatibilizer to the surface of the clay or gallery spacing. In still other embodiments, the compatibilizer may be polymerized in situ in the gallery spacing.

([2R¹R²R³R⁴N⁺]nH₂O)(Al_{2-y}Mg_{y})Si₄O₁₀(OH)₂+X^{m+}→([X^{m+}][R¹R²R³R⁴N⁺]nH₂O)(Al_{2-y}Mg_{y})Si₄O₁₀(OH)₂ (Eq. 1)

Grafting of the compatibilizer on clay surface/gallery may be achieved by two techniques, either by attaching polymer chain on the surface or via in-situ polymerization. The grafting of polymer chains (for example, polymaleic anhydride chains) onto the surface of clay nanoparticles may be achieved by the synthesis of linear macromolecules using a controlled/living polymerization technique followed by organic reactions such as addition and other coupling reactions to immobilize the polymers onto the nanoparticle surface or onto the surface of the gallery spaces and functionalize the surface of clay nanoparticles with pre-synthesized polymer chains. In certain embodiments, this method does not require the pre-functionalization of the clay surface. Alternatively, the polymer chain may be grafted to a clay surface by building the polymer from a functional group on the clay surface. For example, hydroxyl groups present on certain clay surfaces exposed on the periphery of clay permit derivatization to appropriate initiating moieties such as for the controlled growth of polymer chains from the surface of the nanoparticles. A high grafting density, similar to a hydrophobic brush, can be prepared using an initiator carrying a anchor group, and the control of the grafting density may be used to control the length of the graft polymer chain. Various polymerization techniques may be used to initiate polymerization of maleic anhydride on the surface of clay.

According to certain embodiments, a pre-formed polymeric compatibilizer having compatibilizing groups may be grafted onto functionality on the clay surface or in the interior surface of the clay gallery spaces to form the surface grafted modified nano-clay particle having compatibilizer polymer(s) grafted thereto. For example, in one aspect “click” chemistry may be used to attached a formed polymer chain of compatibilizer groups, such as, for example, polymaleic anhydride or other polymeric compatibilizing groups, to the clay surface functionality, such as surface hydroxyl groups. As shown in Scheme 1, surface hydroxyl groups may be reacted with CO and sodium azide in the presence of the polymeric group to form clay surface azide groups. The acyl azide groups are then reacted with a polymaleic anhydride chain having a terminal alkyne using click chemistry to graft the polymaleic anhydride functionality to the clay surface. Other conventional grafting to processes may be used to graft the compatibilizer polymeric moiety to the clay surface and are within the broad scope of the present disclosure.

[chemical structure]

In other embodiments, a compatibilizing polymer may be grafted from the clay surface or the surface of the gallery spacing, for example, by reacting functionality on the clay surface to form an initiator site, such as a halogen, alkene, alcohol, amine, or other functionality that may serve as an initiator site from which to form a polymer chain. For example, in the presence of compatibilizing monomer, such as maleic anhydride and optionally a polymerization catalyst, the initiator site may react with the monomer to initiate polymerization followed by reaction of additional monomer groups to form the grafted from polymer on the surface of the clay, thus forming the surface modified nano-clay particle after chain termination (see Scheme 2). Other conventional grafting from polymerization processes may be used to graft the compatibilizer polymeric moiety from the clay surface and are within the broad scope of the present disclosure.

In other embodiments, in situ polymerization within the clay particle gallery spacing may be used to install the compatibilizer in the clay particle According to these embodiment, the clay may be dispersed in a solvent and monomers added to the dispersion. The monomers may diffuse into the gallery spaces and then be polymerized in situ within the gallery spacing to form an intercalated compatibilizer species. Polymerization may be initiated by an initiator or catalyst or by thermal or light methods. In situ polymerization of maleic anhydride is represented in Scheme 3 to provide intercalated polymaleic anhydride in the gallery spacing of the modified nano-clay.

[chemical structure]

Suitable compatibilizers for modifying the nano-clay particles, by intercalating within the gallery spaces, grafting to the particles, or polymerizing in situ may include, compatibilizer selected from the group consisting of maleic anhydride, polymaleic anhydride, polyethylene-g-maleic anhydride, polypropylene-g-maleic anhydride, poly(ethylene-co-methacrylic acid)-Zn, ethylene-VAc-CO, polyvinyl alcohol, ethylene-butyl acrylate-glycidyl methacrylate, other methacrylate-based polymeric compatibilizers, polycaprolactone polyesters, polycaprolactone-poly(tetramethylene glycol) block polyols, styrene-butadiene-styrene triblock polymers, styrene-isoprene-styrene triblock polymers, and ethylene acrylate.

In specific embodiments, the compatibilizer may be maleic anhydride, polymaleic anhydride, polyethylene-g-maleic anhydride, or polypropylene-g-maleic anhydride. In various embodiments, the maleic anhydride, polymaleic anhydride, polyethylene-g-maleic anhydride, or polypropylene-g-maleic anhydride is at least partially intercalated within the gallery spacing of the clay particles, grafted to the clay particles, and/or polymerized within the clay gallery spacing using in-situ polymerization. According to specific embodiments, the maleic anhydride, polymaleic anhydride, polyethylene-g-maleic anhydride, or polypropylene-g-maleic anhydride is deposited or adsorbed on at least a portion of a surface of the clay particles. According to other embodiments, the maleic anhydride, polymaleic anhydride, polyethylene-g-maleic anhydride, or polypropylene-g-maleic anhydride is at least partially intercalated within the gallery spacing of the clay particles, for example by either an ion exchange process or an in situ polymerization process.

According to various embodiments, intercalating the compatibilizer into the gallery spacing of the clay or grafting the compatibilizer on the clay surface may make the clay more compatible with the polymers, hence eliminating the use of compatibilizer dispersed in the polymer matrix phase. Further, intercalating or grafting the compatibilizer in or on the clay allows for the use of less compatibilizer compared to conventional clay polymer nanocomposites. While not intending to be limited by any theory, it is believed that by associating the compatibilizer with the clay, such as by intercalating in the gallery spacing or grafting to the clay, the clay is made more compatible with the polymeric matrix, thereby reducing the amount of compatibilizer to make a stable nano-clay polymer nanocomposite. In specific embodiments, the modified nano-clay may comprise less than 10% by weight of the compatibilizer, for example from 0.1% to 10% by weight of the compatibilizer.

In still other embodiments of the modified nano-clay materials of the present disclosure, the modifying compound may be a scavenger compound intercalated within the gallery spacing of the clay particles. In one embodiment, the scavenging compound may be an oxygen scavenger. According to various embodiments the oxygen scavenger may be selected from the group consisting of a transition metal ion, a transition metal ion salt, hydroquinone, methylethylketoxime, N,N-diethyl hydroxylamine, hydrazine, carbohydrazide, ascorbic acid, and combinations of any thereof. According to specific embodiments, the oxygen scavenger may be an iron transition metal ion, a copper transition metal ion, any other transition metal ion with multiple oxidation states, and transition metal ion salts thereof. Other oxygen scavengers known in the art may also be used. Nano-clay polymer nanocomposites comprising oxygen scavenging materials may be useful, for example, in packaging material for food, medicines, and electronics, to provide longer shelf life to them. Conventional scavenging agents include iron compounds used in the form of permeable sachets filled with the iron-compound (i.e., iron carbonate, iron/sodium alloy, etc.) and placed into the food or electronics package where oxygen readily permeates the sachet and reacts with the scavenging compound. These conventional oxygen scavengers are based on the principle of iron oxidation. However in various embodiments of the present disclosure, all the transition metal ions (TMI), which are susceptible to oxidation in the presence of air, can potentially be used as oxygen scavengers. According to certain embodiments, the nanoscale organoclays of the present disclosure may be made compatible with both transition metal compounds or TMIs and polymers, and thus may serve as media for the introduction of TMI into polymer matrices. Introducing oxygen scavengers, such as iron or other transition metal ions, into the clay will not only introduce oxygen scavenging properties but may also improve the thermal characteristic or other physical characteristics of the clay and of the resulting polymer nanocomposites. For example, in certain embodiments, clays modified with transition metal ion scavenger compounds or other oxygen scavenger compounds may also improve thermal properties, antibiofouling properties, antimicrobial properties, or may be used for biomedical applications for controlled release of the transition metal ions. For example, copper based scavenger compounds or other transition metal scavengers may also display antimicrobial properties in the nanocomposite having a dispersed phase of a clay modified with copper-based or other transition metal-based scavenging moieties.

According to various embodiments, an ion exchange reaction may introduce transition metal ions into the gallery spacing of clay and in other embodiments, the TMI may be adsorbed onto the surface of clay. When a clay is placed in a solution of a given electrolyte, such as a TMI, an ion exchange occurs between the ions of the clay (y) and the ions of the electrolyte (Xⁿ⁺), as displayed in the reaction as shown in equation 2.

Xⁿ⁺+Na_{y}(Al_{2-y}Mg_{y})Si₄O₁₀(OH)₂→([Xⁿ⁺]_{y/2}nH₂O)(Al_{2-y}Mg_{y})Si₄O₁₀(OH)₂+yNa_{aq} (Eq. 2)

Equation 2 could also apply to the exchange of a cationic organic surfactant in an inorganic mineral clay. The modified reaction that would ensue is displayed below as Equation 3.

Na_{y}(Al_{2-y}Mg_{y})Si₄O₁₀(OH)₂+2R¹R²R³R⁴N⁺→([2R¹R²R³R N⁺]_{y/2}nH₂O)(Al_{2-y}Mg_{y})Si₄O₁₀(OH)₂ (Eq. 3)

where R¹R²R³R⁴N⁺ is an example of an tetraalkylammonium organic surfactant (R¹, R², R³ and R⁴ are each independently C₁-C₂₀ alkyl) that could be present in an organoclay. These kind of reaction will also be applicable for introducing other polar molecules, such as organic scavengers, in the gallery spacing of clay.

Conventional organoclays have been considered to be inert nanofillers for polymer nanocomposite materials if their surface chemistry is not considered. However, the present disclosure demonstrates that the surfactant structure and the internal structure of an organoclay may both affect various properties of clay. Further, the advantages of scavenger modified nano-clays may be harnessed by introducing such modified clay into the polymer matrices to improve various polymeric properties. In addition, introduction of transition metal ions into the clay gallery spacing may also serve other purposes, such as improving thermal stability of an organoclay under the high-temperature melt-mixing process of nanocomposite synthesis. Further, the presence of metal ions may improve thermal stability of nano-clay and thereby reduce degradation of organic surfactant during processing. The surface chemistry of organoclays may allow for chemical modification of the clay and improved compatibility and dispersion within the polymer matrix. In order to elucidate the influence of TMI on the structure, morphology, and properties of organoclays, both synthetic and commercially available organoclays may be modified with high oxidation TMI, such as Cu²⁺ or Fe³⁺, and optionally followed by the reduction of TMI via sodium borohydride.

According to one embodiment, the clay modification may include transition metal ion agents as the crystallohydrate salt. TMI hydrate salts (e.g., CuCl₂.2H₂O and FeCl₃.6H₂O) are typically soluble in methanol, water, ethanol and a series of other polar solvents, which may allow for easy intercalation and incorporation of TMI into the gallery spacing of the organoclays via solution. The TMI hydrate salts will typically not degrade at high temperatures, and thus may serve as thermally-resistant nanofillers within the organoclays themselves, which may then be useful for high temperature melt mixing for polymers with higher melting temperatures. The maximum amount of cations per unit mass that may be exchanged by clay is defined as its cation exchange capacity (“CEC”). The clay layers are negatively charged due to presence of unsatisfied O²⁻ on the surface (from silicates), uncompensated internal charges, loss of interlayer cations, and/or OH dissociation. When clay particles are suspended in ionic solution sites, the cations in solutions may replace the interlayer exchangeable cations, such as the cations in the gallery spacing of the clay. The exchange of ions may involve adsorption and desorption and may be an equilibrium process. It is believed that when the clay is placed in a solution of given electrolyte, an exchange occurs between the ions of the clay (Y) and transition metal ions of the electrolyte (Xⁿ⁺(aq)) as given in equation 4, showing a reaction that may occur in inorganic clays during modification by TMI.

X⁺²(aq)+2RN_{S}⁺(clay)→X_{S}⁺²(clay)+2RN⁺(aq) (Eq. 4)

The direction of the reaction may be controlled as it depends on the nature of TMI, ions of the clay and their concentration. For example, the reaction can move to the right by increasing the concentration of TMI (i.e., X²⁺) in solution. Absorption may take place due to the attraction of positively charged ions to the negatively charged layers of clays. The number of cations adsorbed varies, depending on the charge of cation. For example, if a monovalent cation is exchanged with a divalent or trivalent cation, then 2 monovalent cations are exchanged for the divalent cation and three monovalent cations are exchanged for a trivalent cation, respectively. Ion exchange can also be pH dependent, wherein a cationic exchange takes place at higher pH.

According to other embodiments, oxygen scavenging transition metal ions may be intercalated into the gallery spacing of the clay at a high oxidation state followed by a reduction process to form a lower oxidation state TMI capable of scavenging oxygen. According to these embodiments, reduction of the TMI oxidation state will enhance the oxygen scavenging properties of these ions when present in the clay. Sodium borohydride (NaBH₄) is a conventional reducing agent and may be used to reduce TMI in situ within the clay gallery spacing due to its good stability in either methanol or ethanol, paired with its solubility in water. Solid NaBH₄ may be dispersed in methanol or other desired solvent being used for modification of clay and then the clay treated with the NaBH₄ dispersion to reduce the intercalated transition metal ions to produce modified nano-clay particles. After being treated with NaBH₄ in methanol, the reduced TMI-modified samples may then be washed with solvent to remove and residual reducing agent or side products. One embodiment of the process comprising the in situ reduction of transition metals ions is given in Equation 5 where a metal ion (M) intercalated in the clay gallery spaces and in the +2 oxidation state is reduced in situ to the 0 oxidation state.

M²⁺(clay)+BH₄⁻+2H₂O→M(clay)+BO₂⁻+2H⁺+3H₂ (Eq. 5)

Due to the availability of reducing agents and the stability of NaBH₄ in a variety of polar solvents, this process may be applied to clay and the experimental protocol for the reduction procedure can be performed in solution of the clay dispersed in a polar solvent. FIGS. 2A and 2B schematically illustrate the appearance of an unmodified organoclay to one treated according to the present embodiments and containing a transition metal ion scavenging compound.

According to various embodiments wherein the modifying compound is a scavenger intercalated within the gallery spaces of the clay particles, the scavenger may be an oxygen scavenger selected from the group consisting of a transition metal ion, a transition metal ion salt, hydroquinone, methylethylketoxime, N,N-diethyl hydroxylamine, hydrazine, carbohydrazide, ascorbic acid, and combinations of any thereof. As used herein regarding scavengers, the term “transition metal ion” may also include the transition metal in the zero (0) oxidation state. According to specific embodiments, the oxygen scavenger may be an iron transition metal ion, a copper transition metal ion, any other transition metal ion with multiple oxidation states, and transition metal ion salts thereof. Non-limiting iron transition metal ions include Fe(0), Fe⁺, Fe²⁺, Fe³⁺, Fe⁴⁺, Fe⁶⁺and combinations and salts thereof. Non-limiting copper transition metal ions include Cu(0), Cu⁺, Cu²⁺, Cu³⁺, Cu⁴⁺ and combinations and salts of any thereof.

In certain embodiments, the modified nano-clay may comprise nano-clay particles, a compatibilizer moiety and a scavenger moiety, individually or together depending on desired end property of polymer nanocomposite material being developed. In specific embodiments, the modified nano-clay particles may comprise dispersed, exfoliated nano-clay particles. In specific embodiments, the modified nano-clay may comprise exfoliated nano-clay particles, a compatibilizer moiety and a scavenger moiety. For example, in certain embodiments, the clay particles may be dispersed and exfoliated by a process comprising mixing a clay aggregate having gallery spacing within the clay structure or a modified clay aggregate having a compatibilizer moiety and/or a scavenger moiety intercalated into the gallery spacing or grafted to or from the surface of the clay with a supercritical fluid to form a contacted clay composition or aggregate, and catastrophically depressurizing the contacted clay composition or aggregate to produce a dispersed, exfoliated nano-clay particles. Methods of producing exfoliated clay particulates are described in U.S. Pat. No. 6,469,073 to Manke et al.; U.S. Pat. No. 6,753,360 to Mielewski et al.; U.S. Pat. No. 7,157,517 to Gulari et al.; and U.S. Pat. No. 7,387,749 to Gulari et al., the disclosures of each of which are incorporated in their entirety by this reference. Further processing systems are described in U.S. nonprovisional patent application Ser. No. ______ entitled Modular Supercritical Fluid Materials Processing System, filed on Mar. 15, 2013, the disclosure of which is incorporated in its entirety by this reference. In general and not to be limited to any specific process, supercritical fluid such as carbon dioxide or other suitable supercritical fluid may be used to process the clay either pre- or post-modification with the modifying compound. Pressurizing and heating the unmodified clay or modified clay with the supercritical fluid may be accomplished by any conventional means. Under supercritical condition a portion of the supercritical fluid is dispersed into gallery spaces of the clay material. It is to be understood that the term “diffuses” mentioned above may be equated to “expands” or “swells” with respect to the supercritical fluid and the aggregated particles. Without intending to be limited by any theory, it is believed that the density properties and the energetic nature of the supercritical fluid allows the supercritical fluid to be dispersed in the gallery spaces of the aggregate materials as they are being mixed in the pressurized and heated supercritical fluid processing vessel. Diffusing the supercritical fluid between the aggregated particles includes maintaining diffusion for between about 10 minutes to 24 hours at supercritical conditions and preferably from 3 to 10 hours, to produce a mixture of supercritical fluid and the aggregate material comprising contacted particles. When there has been sufficient mixing of the clay and the supercritical fluid, such that a portion of the supercritical fluid is dispersed in gallery spaces of the clay material to form the mixture of the supercritical fluid and the clay material, the mixture may be expelled from the supercritical fluid processing vessel, through the intermediate pressure release valve, into a collection vessel. The collection vessel is maintained at a pressure less than the pressure of the mixture in the supercritical fluid processing vessel, such as, for example about atmospheric pressure or even reduced pressure. The intermediate pressure release valve is configured to release the mixture of the supercritical fluid and aggregate material, for example at up to sonic velocity. As the mixture is expelled from the supercritical fluid processing vessel through the intermediate pressure release valve and into the collection vessel, the mixture of supercritical fluid and clay material is catastrophically depressurized, wherein the supercritical fluid, including the supercritical fluid in the gallery spaces, expands where the molecules of the supercritical fluid move away from each other at a sonic velocity and the clay particles also move away from each other at a similar apparent velocity. Due to a portion of the supercritical fluid molecules being entrained in the clay gallery spaces, the clay material is torn apart during the catastrophic depressurization by forces when the supercritical fluid molecules expand against the gallery walls and layers of the clay material. After and as a result of the catastrophic depressurization, the contacted clay material particles are exfoliated such that the particles are substantially delaminated and disordered, preventing reaggregation of the structures, and producing a dispersed, exfoliated clay material, which may be modified nano-clay particles have the modifying compound intercalated in or attached to, or which may then be treated with a modifying compound as described herein to form the modified nano-clay particles.

According to another embodiment, the present disclosure provides polymer nanocomposite material comprising a modified nano-clay according to any of the embodiments described herein. In certain embodiments, the disclosure provides a polymer nanocomposite material comprising a matrix phase comprising a polymer and a dispersed phase comprising modified nano-clay particles, wherein the modified nano-clay particles may comprise nano-scale clay particles having gallery spacing within the clay structure; and a modifying compound selected from a compatibilizer moiety, a scavenger moiety or combinations thereof, wherein the compatibilizer moiety or the scavenger moiety is intercalated within the gallery spacing of the clay particles or deposited or adsorbed on at least a portion of a surface of the clay particles. According to specific embodiments, the modified nano-clay may be homogeneously dispersed in the polymer matrix phase.

In particular embodiments, the modified nano-clay particles may comprise less that 10% by weight of any of the compatibilizer moieties, as described herein. For example, in various embodiments, the modifier may be a compatibilizer moiety selected from maleic anhydride, polymaleic anhydride, polyethylene-g-maleic anhydride, or polypropylene-g-maleic anhydride, wherein the compatibilizer moiety is at least partially intercalated within the gallery spacing of the clay particles or grafted to the clay particles. For example, in specific embodiments, the modified nano-clay in the dispersed phase may comprise from about 1% to about 20% by weight of the total polymer nanocomposite material. As described herein, the use of lower loadings of compatibilizers may improve the physical properties of the polymer nanocomposite material. Large loadings of conventional compatibilizers may degrade polymer physical properties such as toughness, strength, stiffness, dimensional stability, modulus, heat deflection temperature, thermal properties, barrier properties, and rust and dent resistance. The polymer nanocomposites of the present disclosure may display improved physical properties due to the lower loading concentrations of the compatibilizers because of the intimate relationship between the compatibilizing moiety and the dispersed nano-clay particles.

According to specific embodiments, the modified nano-clay may be homogeneously dispersed in the polymer matrix phase. As described herein, homogeneous dispersion of clay in a polymer matrix may be difficult to achieve, for example, due to the difference in polarity between the charged clay particles in the dispersed phase and a neutral or lipophilic polymer phase. Conventional methods for achieving homogeneous dispersion of the dispersed clay particulate phase may include utilizing large amounts, such as from 20% to even about 30% by weight of a compatibilizer compound mixed into the polymer matrix. Large compatibilizer loading may result in degradation of certain physical properties of the nanocomposite material. In contrast, the various embodiments of the present disclosure can utilize lower amounts of compatibilizer, such as from 1% to 10% by weight of the polymer nanocomposite, by intimately associating the compatibilizer with the dispersed clay particulates.

According to other embodiments of the polymer nanocomposite material, the nanocomposite material may comprise a modified nano-clay particulate which comprise less than 10% by weight of a scavenger moiety, such as described herein. According to these embodiments, the scavenger moieties may be intercalated within the gallery spacing of the clay, as described herein. In specific embodiments, the scavenger may be an oxygen scavenger, such as an oxygen scavenger selected from the group consisting of a transition metal ion, hydroquinone, methylethylketoxime, N,N-diethyl hydroxylamine, hydrazine, carbohydrazide, ascorbic acid, and combinations of any thereof. Details on oxygen scavengers and processes for intercalating the oxygen scavenger in the gallery spacing of the clay is described in detail herein.

The polymer nanocomposites of various embodiments of the present disclosure may comprise any conventional polymeric material, such as thermoplastic and thermoset polymers, that can be utilized as a matrix phase in a polymer nanocomposite material. According to various embodiments, the polymer that may be selected from the group consisting of polyvinyl chloride (PVC), polyethylene terephthalate, polyacrylonitrile, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof. In particular embodiments, the polymer may be a relatively non-polar, hydrophobic polymer, which may require a compatibilizing moiety to ensure homogeneous dispersion of the dispersed clay particulates in the polymer matrix. In specific embodiments, the polymer may be a polyolefin, for example in certain embodiments the polymer may be polyethylene or polypropylene.

Still other embodiments of the present disclosure provide for articles of manufacture comprising the polymer nanocomposite material according to the various embodiments described herein. The article of manufacture may be manufactured using conventional methods for producing, molding or extruding polymeric nanocomposite materials. Articles of manufacture may include, but are not limited to, articles in the automotive industry, such as car body parts, and in packaging industry.

Further embodiments of the present disclosure provide for a process for producing modified nano-clay particles comprising mixing a clay aggregate having gallery spacing within the clay structure with a modifying compound selected from a compatibilizer moiety, a scavenger moiety or combinations thereof; and intercalating the modifying compound into the gallery spacing if the clay structure or grafting the modifying compound onto the clay to provide a modified clay aggregate. In particular embodiments, the modified nano-clay may be an exfoliated modified nano-clay, for example, where the clay particles are modified and then treated to an exfoliation process or where the clay particles are exfoliated and then treated to the modification process (i.e., intercalating into gallery spacing or grafting to/from the surface of the clay).

According to various embodiments of the processes herein, the intercalating step for modifying the clay, such as for intercalating the modifying compound into gallery spacing of the clay may comprise mixing the clay aggregate or particulates (including in some embodiments, exfoliated clay particulates) with an organic or aqueous solvent comprising the modifying compound to produce a mixture of the clay and solvent, followed by the step of removing the organic solvent to provide the modified clay particle or aggregate material. According to other embodiments, the process may include grafting the modifying compound on to the clay to provide a modified clay particle or aggregate. Grafting the modifying polymer, such as a compatibilizing polymer may be by a grafting to or grafting from process, as described herein. Examples of clay particles and aggregates suitable for the methods herein include those clay materials described herein. In specific embodiments, the clay may be a particle or aggregate is selected from the group consisting of a kaolin-serpentine clay, a sepolite clay, a palygorskite clay, a talc pyrophylite, a smectite clay, a vermiculite clay, a chlorite clay, a mica clay and mixtures of any thereof.

According to specific embodiments, the clay may be a dispersed, exfoliated clay, such as a nano-clay particulate may be a supercritical fluid processing method, such as described herein. In specific embodiments, the clay may be an aggregate material that has been modified prior to exfoliating. In other embodiments, the clay may be exfoliated prior to modifying the clay by intercalating the modifying compound or grafting the modifying compound to/from the surface of the clay. In still other embodiments, the clay may be modified during the exfoliation process, wherein the modifying compound may be added to the mixture of the clay and the supercritical fluid to produce a modified clay supercritical fluid mixture that is then exfoliated by catastrophic depressurization. According to various embodiments, the process described herein may comprise exfoliating the clay aggregate, wherein exfoliating the clay aggregate comprises mixing the clay aggregate with a supercritical fluid to form a contacted clay aggregate, which may optionally include the modifying compound; and catastrophically depressurizing the contacted clay aggregate to produce the exfoliated, nano-clay particles optionally comprising the modifying compound.

According to various embodiments of the processes, the modifying compound may be a compatibilizer moiety, such as any of the compatibilizer moieties described herein. As described herein the compatibilizer moiety may be intercalated into the gallery spaces of the clay, such as by an in situ polymerization process, or the compatibilizer moiety may be attached to a surface of the clay or interior surface of the gallery spaces, such as by a grafting to or grafting from polymerization process, as described herein. In specific embodiments, the modifying compound may be a compatibilizer moiety selected from maleic anhydride, polymaleic anhydride, polyethylene-g-maleic anhydride, or polypropylene-g-maleic anhydride.

According to other embodiments of the processes, the modifying compound may be a scavenger moiety, such as any of the scavenger moieties described herein. The scavenger moiety may be intercalated within the gallery spacing of the clay particles or aggregate, such as by the methods described herein. In specific embodiments, the scavenger moiety may be an oxygen scavenging moiety, such as an oxygen scavenger selected from the group consisting of a transition metal ion, hydroquinone, methylethylketoxime, N,N-diethyl hydroxylamine, hydrazine, carbohydrazide, ascorbic acid, and combinations of any thereof.

The process for producing the modified clay particulates described herein may further comprise the step of dispersing the modified nano-clay particles into a polymer matrix to produce a polymer nanocomposite material. Dispersing the modified nano-clay particles into the polymer matrix may be performed by conventional means, including mixing above the polymer melt temperature, extruding a mixture of nano-clay particles and the polymer, solvent based polymerization where clay and polymer interact in presence of solvent and solvent is then removed, or any other conventional means. In one embodiment, mixing the nano-clay particles with the polymer may be accomplished under supercritical fluid conditions, wherein the clay, the modifying compound, a supercritical fluid and the polymer are mixed under supercritical conditions such that the modifying compounds, supercritical fluid, and polymer are intercalated into gallery spaces in the clay and then the mixture catastrophically depressurized to provide an exfoliated modified nano-clay polymer nanocomposite which may be collected by an extruder to homogenized.

Still other embodiments of the present disclosure may include a process for producing a polymer nanocomposite material comprising modified nano-clay particulates, as described herein. According to embodiments of the process, producing the polymer nanocomposite material may comprise homogeneous mixing of a modified nano-clay particulate, as described herein, with a polymer, for example under melt conditions, to provide the polymer nanocomposite material. Other methods of mixing the modified nano-clay particulate with the polymer, including supercritical fluid processing, may be apparent to one of skill in the art based on a thorough reading of the present disclosure and are within the overall scope of the compositions and processes described and claimed herein.

One of skill in the art would understand that the present disclosure is not limited to the embodiments and configurations set forth and described herein. The present disclosure also includes other configuration of the various components described herein that would be apparent to one of skill in the art reading the present disclosure.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the specifications and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, for any reference made to patents and printed publications throughout this specification, each of the cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A modified nano-clay for a polymer nanocomposite material comprising:
nano-scale clay particles having gallery spacing within the clay structure; and
a modifying compound selected from a compatibilizer moiety, a scavenger moiety or combinations thereof,
wherein the compatibilizer moiety or the scavenger moiety is intercalated within the gallery spacing of the clay particles, polymerized within the gallery spaces or on the surface of the clay, grafted to or from the clay particles, or deposited on at least a portion of a surface of the clay particles.

2. The modified nano-clay according to claim 1, wherein the nano-scale clay particles have a size ranging from 500 nm to 3000 nm.

3. The modified nano-clay according to claim 2, wherein the modified nano-clay has a clay stack thickness of 1 nm to 100 nm.

4. The modified nano-clay according to claim 1, wherein the clay particles are particles of a silicate clay selected from the group consisting of a kaolin-serpentine clay, a sepolite clay, a palygorskite clay, a talc pyrophylite, a smectite clay, a vermiculite clay, a chlorite clay, a mica clay and mixtures of any thereof.

5. The modified nano-clay according to claim 1, wherein the modifying compound is a compatibilizer selected from the group consisting of maleic anhydride, polymaleic anhydride, polyethylene-g-maleic anhydride, polypropylene-g-maleic anhydride, poly(ethylene-co-methacrylic acid)-Zn, ethylene-VAc-CO, polyvinyl alcohol, ethylene-butyl acrylate-glycidyl methacrylate, other methacrylate-based polymeric compatibilizers, polycaprolactone polyesters, polycaprolactone-poly(tetramethylene glycol) block polyols, styrene-butadiene-styrene triblock polymers, styrene-isoprene-styrene triblock polymers, and ethylene acrylate.

6. The modified nano-clay according to claim 5, wherein the compatibilizer is maleic anhydride, polymaleic anhydride, polyethylene-g-maleic anhydride, or polypropylene-g-maleic anhydride.

7. The modified nano-clay according to claim 6, wherein the maleic anhydride, polymaleic anhydride, polyethylene-g-maleic anhydride, or polypropylene-g-maleic anhydride is at least partially intercalated within the gallery spacing of the clay particles, grafted to the clay particles, and/or polymerized within the clay gallery spacing using in-situ polymerization.

8. The modified nano-clay according to claim 7, wherein the modified nano-clay comprises less than 10% by weight of the compatibilizer.

9. The modified nano-clay according to claim 7, wherein the maleic anhydride, polymaleic anhydride, polyethylene-g-maleic anhydride, or polypropylene-g-maleic anhydride is deposited or adsorbed on at least a portion of a surface of the clay particles.

10. The modified nano-clay according to claim 1, wherein the modifying compound is a scavenger intercalated within the gallery spaces of the clay particles, and wherein the scavenger is an oxygen scavenger selected from the group consisting of a transition metal ion, a transition metal ion salt, hydroquinone, methylethylketoxime, N,N-diethyl hydroxylamine, hydrazine, carbohydrazide, ascorbic acid, and combinations of any thereof.

11. The modified nano-clay according to claim 10, wherein the oxygen scavenger is an iron transition metal ion, a copper transition metal ion, any other transition metal ion with multiple oxidation states, and transition metal ion salts thereof.

12. The modified nano-clay according to clay 1, wherein the modified nano-clay particles comprise dispersed, exfoliated nano-clay particles.

13. The modified nano-clay according to claim 1, wherein the modified nano-clay comprises exfoliated nano-clay particles, a compatibilizer moiety, and a scavenger moiety.

14. A polymer nanocomposite material comprising:
a matrix phase comprising a polymer; and
a dispersed phase comprising modified nano-clay particles,
wherein the modified nano-clay particles comprise:
nano-scale clay particles having gallery spacing within the clay structure; and
a modifying compound selected from a compatibilizer moiety or a scavenger moiety,
wherein the compatibilizer moiety or the scavenger moiety is intercalated within the gallery spacing of the clay particles, polymerized within the gallery spaces or on the surface of the clay, grafted to or from the clay particles, or deposited on at least a portion of a surface of the clay particles.

15. The polymer nanocomposite material according to claim 14, wherein the modified nano-clay particles comprise less that 10% by weight of a compatibilizer moiety selected from maleic anhydride, polymaleic anhydride, polyethylene-g-maleic anhydride, or polypropylene-g-maleic anhydride, wherein the compatibilizer moiety is at least partially intercalated within the gallery spacing of the clay particles or grafted to the clay particles.

16. The polymer nanocomposite material according to claim 14, wherein the modified nano-clay in the dispersed phase comprises from about 1% to about 20% by weight of the polymer nanocomposite material.

17. The polymer nanocomposite material according to claim 14, wherein the modified nano-clay is homogeneously dispersed in the matrix phase.

18. The polymer nanocomposite material according to claim 14, wherein the modified nano-clay particles comprise less that 10% by weight of a scavenger moiety intercalated within the gallery spaces of the clay particles, and wherein the scavenger is an oxygen scavenger selected from the group consisting of a transition metal ion, hydroquinone, methylethylketoxime, N,N-diethyl hydroxylamine, hydrazine, carbohydrazide, ascorbic acid, and combinations of any thereof.

19. The polymer nanocomposite material according to claim 14, wherein the polymer is selected from the group consisting of a polyolefin selected from the group consisting of polyvinyl chloride (PVC), polyethylene terephthalate, polyacrylonitrile, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof.

20. The polymer nanocomposite material according to claim 19, wherein the polymer is polyethylene or polypropylene.

21. A process for producing modified nano-clay particles comprising:
mixing a clay aggregate having gallery spacing within the clay structure with a modifying compound selected from a compatibilizer moiety, a scavenger moiety or combinations thereof; and
intercalating the modifying compound into the gallery spacing if the clay structure, polymerizing the modifying compound in situ in the gallery spacing, grafting the modifying compound to or from the clay to provide a modified clay aggregate, or adsorbing the modifying compound on the surface of the clay.

22. The process according to claim 21, further comprising exfoliating a clay aggregate wherein exfoliating the clay aggregate comprises mixing the clay aggregate with a supercritical fluid to form a contacted clay aggregate; and
catastrophically depressurizing the contacted clay aggregate to produce the exfoliated, nano-clay particles.

23. The process according to claim 21, wherein intercalating the modifying compound comprises mixing the clay aggregate with an organic solvent comprising the modifying compounds; and
removing the organic solvent to provide the modified clay aggregate.

24. The process according to claim 21, wherein the clay aggregate is selected from the group consisting of a kaolin-serpentine clay, a sepolite clay, a palygorskite clay, a talc pyrophylite, a smectite clay, a vermiculite clay, a chlorite clay, a mica clay and mixtures of any thereof.

25. The process according to claim 21, wherein the modifying compound is a compatibilizer moiety selected from maleic anhydride, polymaleic anhydride, polyethylene-g-maleic anhydride, or polypropylene-g-maleic anhydride.

26. The process according to claim 21, wherein the modifying compound is a scavenger moiety intercalated within the gallery spaces of the clay particles, and wherein the scavenger is an oxygen scavenger selected from the group consisting of a transition metal ion, hydroquinone, methylethylketoxime, N,N-diethyl hydroxylamine, hydrazine, carbohydrazide, ascorbic acid, and combinations of any thereof.

27. The process according to claim 21, further comprising dispersing the modified nano-clay particles in a polymer matrix to produce a polymer nanocomposite material.

28. An article of manufacture comprising the polymer nanocomposite material according to claim 14.
